(19) United States
(12) Patent Application Publication
(10) Pub. No.: US 2025/0271652 A1
(43) Pub. Date: Aug. 28, 2025

(54) INFORMATION PROCESSING APPARATUS, INFORMATION PROCESSING METHOD, METHOD OF GENERATING LEARNING MODEL, AND NON-TRANSITORY COMPUTER READABLE MEDIUM

(71) Applicant: Yokogawa Electric Corporation, Tokyo (JP)

(72) Inventor: Yasunori YOKOYAMA, Tokyo (JP)

(73) Assignee: Yokogawa Electric Corporation, Tokyo (JP)

(21) Appl. No.: 19/053,689

(22) Filed: Feb. 14, 2025

(30) Foreign Application Priority Data
Feb. 27, 2024 (JP) 2024-027741

(51) Int. Cl. G02B 21/00; G01N 21/64; G06T 5/50; G06T 5/70

(52) U.S. Cl. CPC G02B 21/008; G01N 21/6458; G02B 21/0076; G06T 5/50; G06T 5/70; G06T 2207/10056; G06T 2207/10064; G06T 2207/20081

(57) ABSTRACT

An information processing apparatus 10 according to the present disclosure includes a controller 11 configured to acquire, based on learning data that associates third images, which are acquired by a fluorescence microscope 1 and has no fluorescence crosstalk, with fourth images, which are acquired by the fluorescence microscope 1 and has fluorescence crosstalk, a learning model constructed by learning the third images corresponding to the fourth images, and generate, based on the acquired learning model, second images with reduced fluorescence crosstalk in first images of a sample S, which are acquired by the fluorescence microscope 1.

### CROSS-REFERENCE TO RELATED APPLICATION

This application claims priority to Japanese Patent Application No. 2024-027741, filed on Feb. 27, 2024, the entire contents of which are incorporated herein by reference.

### TECHNICAL FIELD

The present disclosure relates to an information processing apparatus, an information processing method, a method of generating a learning model, and a non-transitory computer readable medium.

### BACKGROUND

Technology related to image processing of images acquired by fluorescence microscopes is conventionally known. For example, Patent Literature (PTL) 1 discloses a spectral optical unit that eliminates pixel misalignment between monochromatic images when obtaining a multicolor image.

### CITATION LIST

### Patent Literature

PTL 1: JP 2008-065144 A

### SUMMARY

An information processing apparatus according to some embodiments includes a controller configured to:
acquire, based on learning data that associates a third image with a fourth image, a learning model constructed by learning the third image corresponding to the fourth image, the third image being acquired by a fluorescence microscope and having no fluorescence crosstalk, the fourth image being acquired by the fluorescence microscope and having fluorescence crosstalk; and
generate, based on the acquired learning model, a second image with reduced fluorescence crosstalk in a first image of a sample, the first image being acquired by the fluorescence microscope.

### BRIEF DESCRIPTION OF THE DRAWINGS

In the accompanying drawings:

FIG. 1 is a schematic diagram illustrating an example of a configuration of a fluorescence microscope having an information processing apparatus according to an embodiment of the present disclosure;

FIG. 2 is a first schematic diagram to explain an example of operations of the information processing apparatus in FIG. 1;

FIG. 3 is a second schematic diagram to explain the example of the operations of the information processing apparatus in FIG. 1;

FIG. 4 is a third schematic diagram to explain the example of the operations of the information processing apparatus in FIG. 1;

FIG. 5 is a fourth schematic diagram to explain the example of the operations of the information processing apparatus in FIG. 1;

FIG. 6 is a fifth schematic diagram to explain the example of the operations of the information processing apparatus in FIG. 1;

FIG. 7 is a sixth schematic diagram to explain the example of the operations of the information processing apparatus in FIG. 1;

FIG. 8 is a seventh schematic diagram to explain the example of the operations of the information processing apparatus in FIG. 1;

FIG. 9 is a flowchart to explain an example of an information processing method executed by the information processing apparatus in FIG. 1; and

FIG. 10 is a schematic diagram to explain a problem of conventional technology.

### DETAILED DESCRIPTION

In conventional technology described in PTL 1, there is room for improvement in reducing fluorescence crosstalk in images acquired by fluorescence microscopes.

It would be helpful to provide an information processing apparatus, an information processing method, a method of generating a learning model, and a non-transitory computer readable medium that can more easily reduce fluorescence crosstalk in an image acquired by a fluorescence microscope.

An information processing apparatus according to some embodiments includes a controller configured to:
acquire, based on learning data that associates a third image with a fourth image, a learning model constructed by learning the third image corresponding to the fourth image, the third image being acquired by a fluorescence microscope and having no fluorescence crosstalk, the fourth image being acquired by the fluorescence microscope and having fluorescence crosstalk; and
generate, based on the acquired learning model, a second image with reduced fluorescence crosstalk in a first image of a sample, the first image being acquired by the fluorescence microscope.

It is thereby possible to more easily reduce fluorescence crosstalk in the image acquired by the fluorescence microscope. The information processing apparatus acquires, based on the learning data, the learning model constructed by learning the third image corresponding to the fourth image. The information processing apparatus generates, based on the acquired learning model, the second image from the first image. Therefore, the information processing apparatus, in contrast to conventional technology, can reduce fluorescence crosstalk using only the images, without acquiring fluorescence spectra. The information processing apparatus can more easily reduce fluorescence crosstalk during simultaneous fluorescence imaging at multiple wavelengths, without depending on variations in the fluorescence spectra of fluorochromes used for the sample. The information processing apparatus can easily reduce fluorescence crosstalk with high accuracy.

In the information processing apparatus according to one embodiment, the controller may be configured to acquire each of the first image and the fourth image, as a fluorescence image of multiple wavelengths when excitation light of multiple wavelengths is simultaneously applied to the sample in an optical system of the fluorescence microscope. Therefore, the information processing apparatus can efficiently acquire the fluorescence images of the wavelengths different from each other in a short time, both in an observation stage in which the sample is actually observed, and in a learning stage in which the learning data is acquired to construct the learning model.

In the information processing apparatus according to one embodiment, the controller may be configured to acquire the third image, as a fluorescence image of a single wavelength when the excitation light is applied, for each single wavelength of the multiple wavelengths, to the sample in the optical system. Therefore, the information processing apparatus can accurately acquire the third image, which includes no fluorescence crosstalk, as teacher data in the learning data.

In the information processing apparatus according to one embodiment, the third and fourth images may be a pair of images that are captured in the same field of view as each other in the fluorescence microscope. This allows the information processing apparatus to acquire the pair of images in which positional information on the sample in the images is maintained in the same field of view as each other. This improves learning accuracy when the learning model is constructed based on the third and fourth images. The information processing apparatus can accurately generate the second image with reduced fluorescence crosstalk from the first image of the sample acquired by the fluorescence microscope.

In the information processing apparatus according to one embodiment, the controller may be configured to acquire, in the fluorescence microscope, multiple pairs of images that are captured in respective multiple fields of view different for each pair from each other. Therefore, the information processing apparatus can also acquire the learning data that includes the more pairs of third and fourth images. The larger the amount of the learning data, the higher the learning accuracy when the learning model is constructed based on the third and fourth images. The information processing apparatus can accurately generate the second image with reduced fluorescence crosstalk, from the first image of the sample acquired by the fluorescence microscope.

In the information processing apparatus according to one embodiment, the controller may be configured to acquire the first image and a pair of the third and fourth images in which at least one of the intensity or application time of excitation light applied to the sample in an optical system of the fluorescence microscope is different from each other.

This also enables the information processing apparatus to acquire the pair of third and fourth images, which are used for learning, with a high signal-to-noise ratio, by increasing the intensity of the excitation light and/or elongating the application time of the excitation light when capturing the images. This improves learning accuracy when the learning model is constructed based on the third and fourth images. On the other hand, the information processing apparatus can also reduce damage to the sample due to the excitation light, by reducing the intensity of the excitation light and/or shortening the application time of the excitation light when capturing the first image used for actual observation. In addition, the information processing apparatus can also shorten the exposure time of an imaging camera contained in each light receiver by shortening the application time of the excitation light, thereby shortening imaging time.

In the information processing apparatus according to one embodiment, the fluorescence microscope may be a confocal microscope. This allows the fluorescence microscope to acquire high-resolution images with little blurring and high contrast.

An information processing method according to some embodiments is an information processing method performed by an information processing apparatus, the information processing method including:
acquiring, based on learning data that associates a third image with a fourth image, a learning model constructed by learning the third image corresponding to the fourth image, the third image being acquired by a fluorescence microscope and having no fluorescence crosstalk, the fourth image being acquired by the fluorescence microscope and having fluorescence crosstalk; and
generating, based on the acquired learning model, a second image with reduced fluorescence crosstalk in a first image of a sample, the first image being acquired by the fluorescence microscope.

It is thereby possible to more easily reduce fluorescence crosstalk in the image acquired by the fluorescence microscope. The information processing apparatus acquires, based on the learning data, the learning model constructed by learning the third image corresponding to the fourth image. The information processing apparatus generates, based on the acquired learning model, the second image from the first image. Therefore, the information processing apparatus, in contrast to conventional technology, can reduce fluorescence crosstalk using only the images, without acquiring fluorescence spectra. The information processing apparatus can more easily reduce fluorescence crosstalk during simultaneous fluorescence imaging at multiple wavelengths, without depending on variations in the fluorescence spectra of fluorochromes used for the sample. The information processing apparatus can easily reduce fluorescence crosstalk with high accuracy.

A method of generating a learning model according to some embodiments is a method of generating the learning model used in the above information processing method, the method including:
acquiring the learning data; and
constructing, based on the acquired learning data, the learning model by learning the third image corresponding to the fourth image.

The information processing apparatus thereby acquires the learning data and constructs the learning model by itself. Therefore, the information processing apparatus can complete, in the single apparatus, processing from the learning stage in which the learning model is constructed to the observation stage in which the sample is actually observed.

In the method of generating the learning model according to one embodiment, the learning model may be a machine learning model that has learned the acquired learning data. This improves the learning accuracy when the learning model is constructed based on the third and fourth images. The information processing apparatus can accurately generate the second image with reduced fluorescence crosstalk, from the first image of the sample acquired by the fluorescence microscope.

A non-transitory computer readable medium according to some embodiments stores a program executable by one or more processors, the program configured to cause the information processing apparatus to execute any one of the above information processing method and the above methods of generating the learning model.

It is thereby possible to more easily reduce fluorescence crosstalk in the image acquired by the fluorescence microscope. The information processing apparatus acquires, based on the learning data, the learning model constructed by learning the third image corresponding to the fourth image. The information processing apparatus generates, based on the acquired learning model, the second image from the first image. Therefore, the information processing apparatus, in contrast to conventional technology, can reduce fluorescence crosstalk using only the images, without acquiring fluorescence spectra. The information processing apparatus can more easily reduce fluorescence crosstalk during simultaneous fluorescence imaging at multiple wavelengths, without depending on variations in the fluorescence spectra of fluorochromes used for the sample. The information processing apparatus can easily reduce fluorescence crosstalk with high accuracy.

According to the present disclosure, it is possible to provide the information processing apparatus, the information processing method, the method of generating the learning model, and the non-transitory computer readable medium that can more easily reduce fluorescence crosstalk in the image acquired by the fluorescence microscope.

The background and problem of conventional technology will be described in more detail.

In conventional fluorescence microscopes, excitation light of multiple wavelengths is applied to a sample such as cells that have been stained with multiple fluorochromes, and fluorescence of multiple wavelengths corresponding to the respective wavelengths of the excitation light is emitted from the sample and detected. The fluorescence of multiple wavelengths, which has been emitted from the sample, passes through various optical elements, and reaches an optical element for wavelength separation, such as a dichroic mirror. The dichroic mirror passes fluorescence of a certain wavelength, while reflects fluorescence of the other wavelengths. The wavelength-separated fluorescence of respective wavelengths is imaged by multiple imaging devices, such as cameras.

FIG. 10 is a schematic diagram to explain a problem of the conventional technology. The wavelength separation of the fluorescence by the above-mentioned dichroic mirror is mainly described with reference to FIG. 10.

As illustrated in FIG. 10, assume that the dichroic mirror has the wavelength characteristic illustrated by the broken line. In this case, fluorescence a and fluorescence b are not completely separated from each other by the dichroic mirror, and part of the fluorescence b mixes into an optical path of the fluorescence a that is guided to a camera. In the present disclosure, this mixing of part of the fluorescence is referred to as “fluorescence crosstalk”. The part of the fluorescence b based on fluorescence crosstalk is not removed by a bandpass filter placed in front of the camera. On the other hand, part of the fluorescence a is similarly mixed into an optical path of the fluorescence b that is guided to another camera. The part of the fluorescence a based on fluorescence crosstalk is not removed by a bandpass filter placed in front of the other camera.

As a result, it is not easy for the conventional fluorescence microscopes to image the fluorescence with high accuracy due to fluorescence crosstalk.

As a method for solving such a problem, an image processing method such as conventional technology described in PTL 1 is known. In this conventional technology, for multiple fluorescence images with mixed fluorescence, a fluorescence image that expresses only individual emission of each fluorochrome is obtained by matrix division of a fluorescence spectrum of each fluorochrome for each pixel.

However, the following problem can be considered with regard to such conventional technology. In general, a fluorescence spectrum of a fluorochrome varies depending on the state of molecules contained in the fluorochrome. The state of the molecules varies depending on conditions such as surrounding pH, temperature, and which molecules the molecules are bound to. In other words, the fluorescence spectrum varies in each experiment. Therefore, in order to accurately execute the image processing method described in PTL 1, it is necessary to acquire the fluorescence spectrum in each experiment. However, accurately acquiring the fluorescence spectrum requires a great deal of time and effort.

It would be helpful to provide an information processing apparatus, a fluorescence microscope, an information processing method, a method of generating a learning model, and a non-transitory computer readable medium that can more easily reduce fluorescence crosstalk in an image acquired by a fluorescence microscope.

An embodiment of the present disclosure will be mainly described below with reference to the attached drawings.

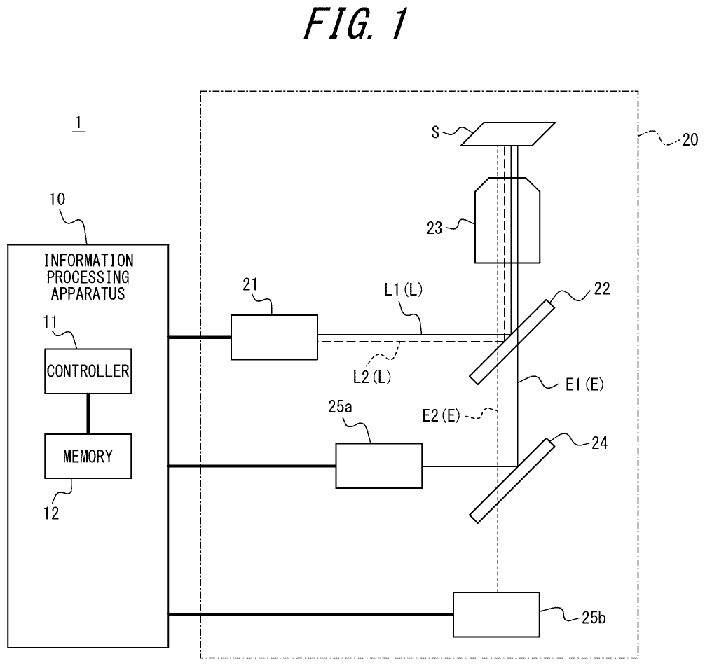

FIG. 1 is a schematic diagram illustrating an example of a configuration of a fluorescence microscope 1 with an information processing apparatus 10 according to the embodiment of the present disclosure. The example of the configuration and functions of the fluorescence microscope 1 with the information processing apparatus 10 according to the embodiment is mainly described with reference to FIG. 1.

The fluorescence microscope 1 according to the embodiment is, as an example, a confocal microscope. The fluorescence microscope 1 has, in addition to the information processing apparatus 10, an optical system 20 connected to the information processing apparatus 10. The optical system 20, for example, simultaneously applies excitation light L of multiple wavelengths to a sample S. In the present disclosure, “excitation light L of multiple wavelengths” may mean, for example, multiple beams of excitation light L that correspond to multiple wavelengths different from each other, or a single beam of excitation light L that has a broad light spectrum with multiple wavelengths different from each other. The phrase “simultaneously apply” may mean that start and end points of application are completely the same, or at least one of a start point or an end point of application is different on condition that application times overlap within a specified time range.

The fluorescence microscope 1 acquires, for the sample S using the optical system 20, fluorescence images of multiple wavelengths corresponding to the excitation light L of respective multiple wavelengths. In the present disclosure, “fluorescence images of multiple wavelengths” mean, for example, multiple images based on multiple types of fluorescence that are emitted from the sample S stained with multiple fluorochromes and that correspond to respective multiple wavelengths different from each other.

The optical system 20 has an applicator 21, a first dichroic mirror 22, an objective lens 23, a second dichroic mirror 24, a first light receiver 25a, and a second light receiver 25b.

The applicator 21 has a light source such as a laser or a light emitting diode (LED). In addition to the light source, the applicator 21 may also have a condenser element such as a lens. The applicator 21 applies, to the first dichroic mirror 22, the excitation light L with wavelengths that match the multiple fluorochromes, which stain the sample S to be observed using the fluorescence microscope 1. The excitation light L includes, for example, first excitation light L1 and second excitation light L2. The light source of the applicator 21 may apply the first excitation light L1 with a first wavelength and the second excitation light L2 with a second wavelength individually or simultaneously based on a control signal from the information processing apparatus 10. The wavelengths of the excitation light L applied by the applicator 21 are within the visible region, for example. Not limited to this, the wavelengths of the excitation light L may be included in the ultraviolet region, the near-infrared region, another infrared region, or the like.

The first dichroic mirror 22 is a mirror that reflects the excitation light L applied from the applicator 21 to the objective lens 23, and transmits fluorescence E, which is described later, emitted from the sample S to the second dichroic mirror 24.

The objective lens 23 is arranged to face the sample S. The objective lens 23 guides, to the sample S, the first excitation light L1 and the second excitation light L2 reflected by the first dichroic mirror 22. The objective lens 23 gathers first fluorescence E1 emitted from the sample S in response to the first excitation light L1 and second fluorescence E2 emitted from the sample S in response to the second excitation light L2, and forms images thereof in the first light receiver 25a and the second light receiver 25b, respectively. The images may be formed in the respective light receivers using not-illustrated imaging lenses.

The second dichroic mirror 24 is a mirror that receives the fluorescence E, which includes the first fluorescence E1 and the second fluorescence E2, transmitted through the first dichroic mirror 22. The second dichroic mirror 24 reflects the first fluorescence E1 to the first light receiver 25a, and transmits the second fluorescence E2 to the second light receiver 25b. The second dichroic mirror 24 separates the first fluorescence E1 and the second fluorescence E2 by wavelength.

The first light receiver 25a has a light detector such as a first imaging camera. The first light receiver 25a receives the first fluorescence E1 from the sample S, which has been gathered by the objective lens 23. The first imaging camera of the first light receiver 25a converts the first fluorescence E1, whose image has been formed by the objective lens 23, into an electrical signal, and outputs the electrical signal to the information processing apparatus 10, as information on a first fluorescence image. The first imaging camera of the first light receiver 25a can receive light in a wavelength band including a wavelength band corresponding to the multiple fluorochromes that stain the sample S. In addition to the above configuration, the first light receiver 25a may also have another optical element such as a bandpass filter.

The second light receiver 25b has a light detector such as a second imaging camera. The second light receiver 25b receives the second fluorescence E2 from the sample S, which has been gathered by the objective lens 23. The second imaging camera of the second light receiver 25b converts the second fluorescence E2, whose image has been formed by the objective lens 23, into an electrical signal, and outputs the electrical signal to the information processing apparatus 10, as information on a second fluorescence image. The second imaging camera of the second light receiver 25b can receive light in a wavelength band including the wavelength band corresponding to the multiple fluorochromes that stain the sample S. In addition to the above configuration, the second light receiver 25b may also have another optical element such as a bandpass filter.

The information processing apparatus 10 includes any processing apparatus that is built integrally with the optical system 20 in the fluorescence microscope 1, or that is electrically and externally connected to the optical system 20. The information processing apparatus 10 may be configured as an apparatus with a dedicated digital circuit that can realize functions described below. The information processing apparatus 10 may include any general-purpose electronic device, such as a personal computer (PC), a tablet PC, a smartphone, or a smartwatch. Not limited to these, the information processing apparatus 10 may include another electronic device dedicated to the fluorescence microscope 1.

The information processing apparatus 10 has a controller 11 and a memory 12.

The controller 11 includes one or more processors, one or more programmable circuits, one or more dedicated circuits, or a combination thereof. In the present disclosure, “processor” is, for example, a general-purpose processor such as a central processing unit (CPU) or a graphics processing unit (GPU), or a dedicated processor specialized for specific processing, but is not limited to these. “Programmable circuit” is, for example, a field-programmable gate array (FPGA), but is not limited to this. “Dedicated circuit” is, for example, an application specific integrated circuit (ASIC), but is not limited to this. The controller 11 is communicably connected to the memory 12 of the information processing apparatus 10, and to the applicator 21, the first light receiver 25a, and the second light receiver 25b of the optical system 20, and controls operations of each component.

The memory 12 includes a storage device such as a hard disk drive (HDD), a solid state drive (SSD), an electrically erasable programmable read-only memory (EEPROM), a read-only memory (ROM), or a random access memory (RAM). The memory 12 stores information necessary to achieve operations of the information processing apparatus 10. The memory 12 stores information obtained by the operations of the information processing apparatus 10. For example, the memory 12 stores a system program, an application program, various types of data acquired by any means such as communication, and the like.

The memory 12 may function as main memory, auxiliary memory, or cache memory. The memory 12 is not limited to being built in the information processing apparatus 10, but may include an external memory device connected by a digital input/output port such as a universal serial bus (USB).

The controller 11 outputs a control signal to the first imaging camera of the first light receiver 25a to acquire the first fluorescence image based on the first fluorescence E1. The controller 11 stores image data on the first fluorescence image in the memory 12. The controller 11 outputs a control signal to the second imaging camera of the second light receiver 25b to acquire the second fluorescence image based on the second fluorescence E2. The controller 11 stores image data on the second fluorescence image in the memory 12.

The controller 11 generates second images in which fluorescence crosstalk in first images of the sample S, which are acquired by the fluorescence microscope 1, is reduced. The controller 11 acquires, based on learning data that associates third images including no fluorescence crosstalk with fourth images including fluorescence crosstalk, a learning model constructed by learning the third images corresponding to the fourth images. The controller 11 generates, based on the acquired learning model, the second images from the first images.

For example, the controller 11 constructs, based on the acquired learning data, the learning model by learning the third images corresponding to the fourth images. In other words, the controller 11 acquires the learning model by constructing the learning model in the information processing apparatus 10 itself. The controller 11 stores the constructed learning model in the memory 12.

The learning model is a machine learning model, based on deep learning or the like, that has learned the acquired learning data. For example, the learning model is a supervised learning model, and is a mathematical model that learns the third images corresponding to the fourth images, using the fourth images as input data and the third images as teacher data. The supervised learning model is, for example, a convolutional neural network that includes an input layer, one or more intermediate layers, and an output layer, but is not limited to this.

The controller 11 performs learning of the supervised learning model. The learning of the supervised learning model may be batch learning or online learning. In the present disclosure, “construct a learning model” means a state in which batch learning has been completed, or online learning has been performed to a certain extent. In the case of online learning, learning may be performed continuously even after learning has been performed to a certain extent.

The above-mentioned processing by the controller 11 is sequentially described below.

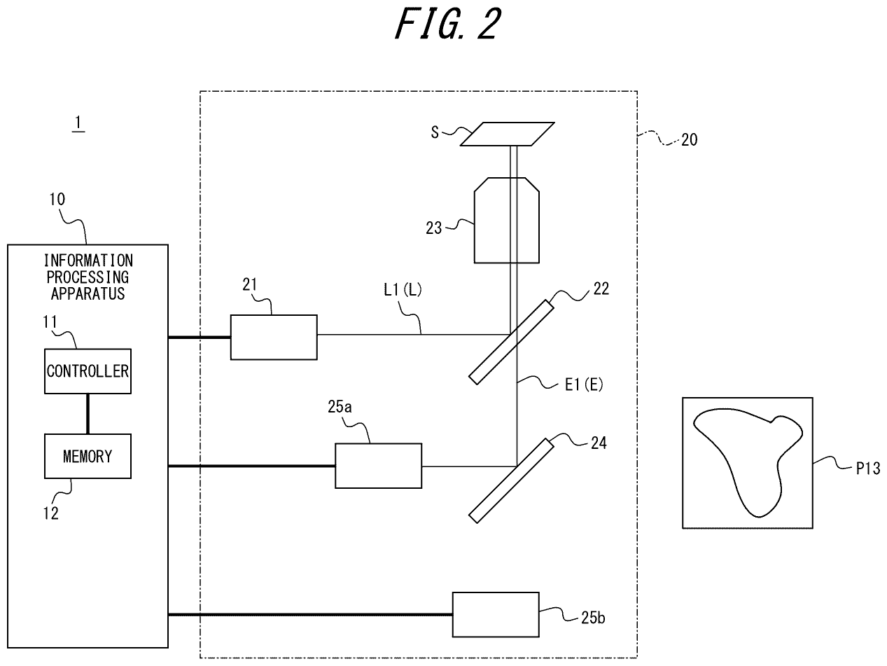

FIG. 2 is a first schematic diagram to explain an example of operations of the information processing apparatus 10 in FIG. 1. Acquisition processing of a third image corresponding to a first fluorescence image P13, which is performed by the controller 11 of the information processing apparatus 10, is mainly described with reference to FIG. 2. The controller 11 acquires the third image, as a fluorescence image of a single wavelength when the excitation light L is applied, for each single wavelength of the multiple wavelengths, to the sample S in the optical system 20.

The controller 11 controls the applicator 21 to apply the first excitation light L1. The first excitation light L1 is reflected by the first dichroic mirror 22, passes through the objective lens 23, and is guided to the sample S. One fluorochrome of the multiple fluorochromes that stain the sample S is excited by the first excitation light L1, and emits the first fluorescence E1. The first fluorescence E1 passes through the objective lens 23, is transmitted through the first dichroic mirror 22, is reflected by the second dichroic mirror 24, and is incident on the first imaging camera of the first light receiver 25a.

The controller 11 stores, as the third image, the first fluorescence image P13 acquired from the first light receiver 25a in the memory 12. The first fluorescence image P13 is an image obtained from only the first fluorescence E1, without including the second fluorescence E2. The controller 11 acquires, for the sample S in the fluorescence microscope 1, multiple third images captured in respective multiple fields of view different from each other.

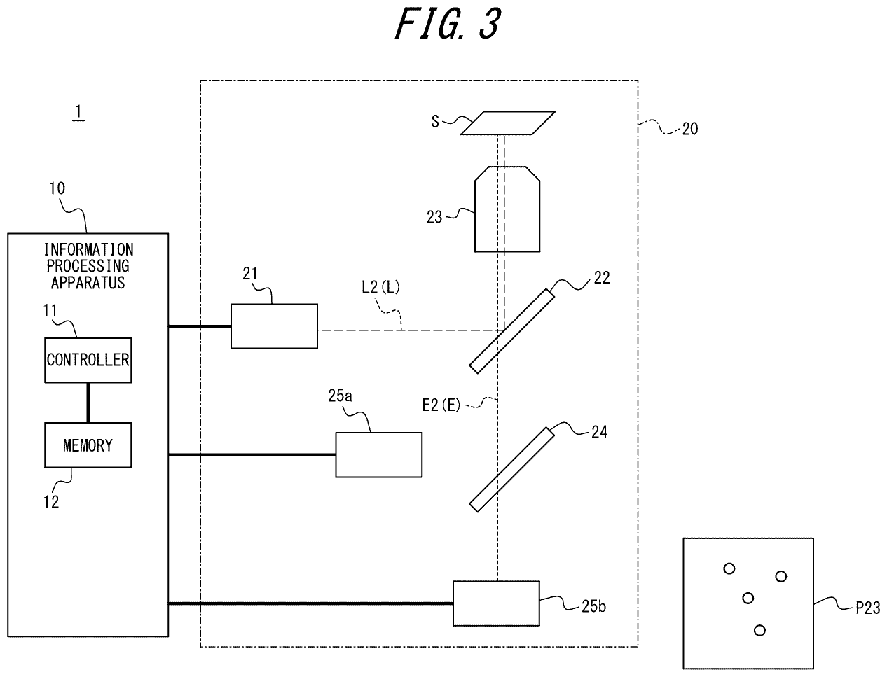

FIG. 3 is a second schematic diagram to explain the example of the operations of the information processing apparatus 10 in FIG. 1. Acquisition processing of a third image corresponding to a second fluorescence image P23, which is performed by the controller 11 of the information processing apparatus 10, is mainly described with reference to FIG. 3.

The controller 11 controls the applicator 21 to apply the second excitation light L2. The second excitation light L2 is reflected by the first dichroic mirror 22, passes through the objective lens 23, and is guided to the sample S. The other fluorochrome of the multiple fluorochromes that stain the sample S is excited by the second excitation light L2, and emits the second fluorescence E2. The second fluorescence E2 passes through the objective lens 23, passes through the first dichroic mirror 22, further passes through the second dichroic mirror 24, and is incident on the second imaging camera of the second light receiver 25b.

The controller 11 stores, as the third image, the second fluorescence image P23 acquired from the second light receiver 25b in the memory 12. The second fluorescence image P23 is an image obtained from only the second fluorescence E2, without including the first fluorescence E1. The controller 11 acquires, for the sample S in the fluorescence microscope 1, multiple third images captured in respective multiple fields of view different from each other. At this time, the multiple fields of view are the same as the multiple fields of view in the acquisition processing of the third images corresponding to the first fluorescence images P13, as described above using FIG. 2.

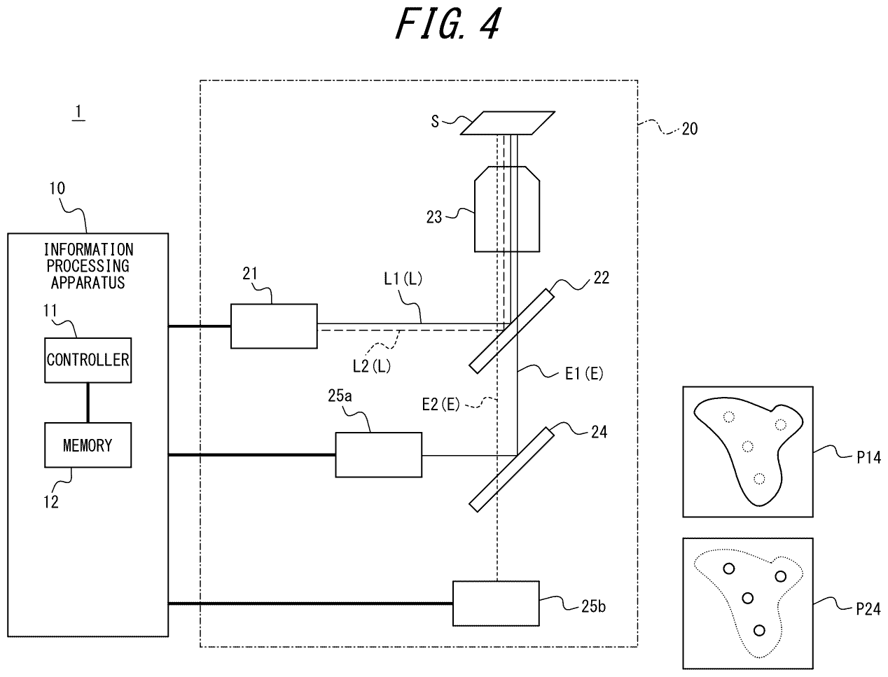

FIG. 4 is a third schematic diagram to explain the example of the operations of the information processing apparatus 10 in FIG. 1. Acquisition processing of fourth images, which is performed by the controller 11 of the information processing apparatus 10, is mainly described with reference to FIG. 4. The controller 11 acquires the fourth images, as fluorescence images of multiple wavelengths when the excitation light L of multiple wavelengths is applied simultaneously to the sample S in the optical system 20 of the fluorescence microscope 1. As an example, operations of simultaneous acquisition of fluorescence at two wavelengths by the information processing apparatus 10 are mainly described.

The controller 11 controls the applicator 21 to apply the first excitation light L1 and the second excitation light L2. The first excitation light L1 and the second excitation light L2 are reflected by the first dichroic mirror 22, pass through the objective lens 23, and are guided to the sample S. One fluorochrome of the multiple fluorochromes that stain the sample S is excited by the first excitation light L1, and emits the first fluorescence E1. The other fluorochrome of the multiple fluorochromes that stain the sample S is excited by the second excitation light L2, and emits the second fluorescence E2.

The first fluorescence E1 and the second fluorescence E2 pass through the objective lens 23, and transmit through the first dichroic mirror 22. The first fluorescence E1 is reflected by the second dichroic mirror 24, and is incident on the first imaging camera of the first light receiver 25a. At this time, part of the second fluorescence E2 is also reflected by the second dichroic mirror 24, and is incident on the first imaging camera of the first light receiver 25a. The second fluorescence E2 passes through the second dichroic mirror 24, and is incident on the second imaging camera of the second light receiver 25b. At this time, part of the first fluorescence E1 also passes through the second dichroic mirror 24, and is incident on the second imaging camera of the second light receiver 25b.

The controller 11 stores, as a fourth image, a first fluorescence image P14 acquired from the first light receiver 25a in the memory 12. The first fluorescence image P14 is an image that includes fluorescence crosstalk of the second fluorescence E2 in the first fluorescence E1. The controller 11 stores, as a fourth image, a second fluorescence image P24 acquired from the second light receiver 25b in the memory 12. The second fluorescence image P24 is an image that includes fluorescence crosstalk of the first fluorescence E1 in the second fluorescence E2.

The controller 11 acquires, for the sample S in the fluorescence microscope 1, multiple fourth images captured in respective multiple fields of view different from each other. At this time, the multiple fields of view are the same as the multiple fields of view in the acquisition processing of the third images, as described above using FIGS. 2 and 3. The third and fourth images constitute a pair of images that are captured in the same field of view as each other in the fluorescence microscope 1. The controller 11 acquires, in the fluorescence microscope 1, multiple pairs of images that are captured in the respective multiple fields of view different for each pair from each other.

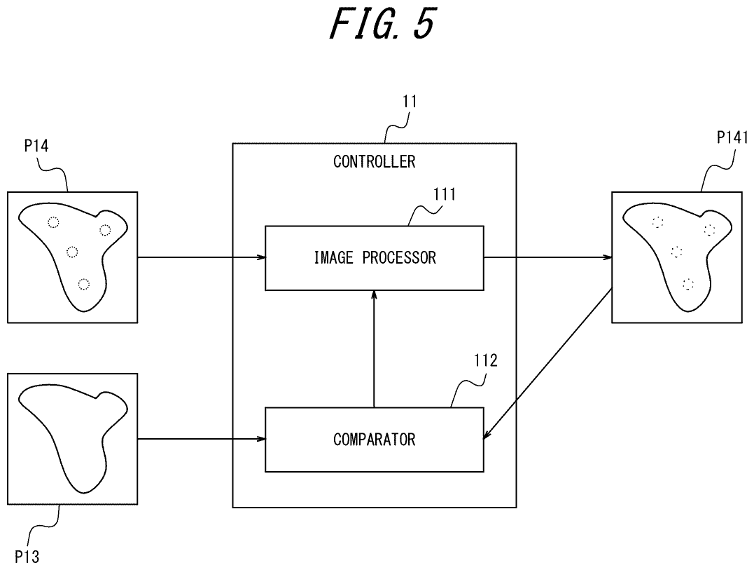

FIG. 5 is a fourth schematic diagram to explain the example of the operations of the information processing apparatus 10 in FIG. 1. The controller 11 includes an image processor 111 and a comparator 112, as multiple functional units that realize the functions. A first example of learning model construction processing performed by the controller 11 of the information processing apparatus 10 is mainly described with reference to FIG. 5. Learning processing of the controller 11 that generates a second image with reduced fluorescence crosstalk, which is similar to the first fluorescence image P13, from the first fluorescence image P14 is mainly described.

The image processor 111 of the controller 11 refers to the first fluorescence image P14 stored in the memory 12. The image processor 111 may perform, for example, processing based on a convolutional neural network having an encoder that captures image features using multiple convolutional layers and a decoder that generates an image by performing inverse operations on the image features using the same number of inverse convolutional layers. The image processor 111 applies, to the first fluorescence image P14, an action to remove the fluorescence crosstalk of the second fluorescence E2, and outputs a first fluorescence image P141 during learning.

The comparator 112 of the controller 11 refers to the first fluorescence image P13 stored in the memory 12 and the first fluorescence image P141 during learning. The comparator 112 compares the first fluorescence image P13 with the first fluorescence image P141 during learning, and adjusts internal parameters of the image processor 111 to bring the first fluorescence image P141 closer to the first fluorescence image P13.

The controller 11 repeatedly performs the above-described processing by the image processor 111 and the comparator 112. The controller 11 performs the same processing on the pairs of first fluorescence images P13 and first fluorescence images P14 captured in the other fields of view. As described above, the controller 11 optimizes the image processor 111 by repeated learning.

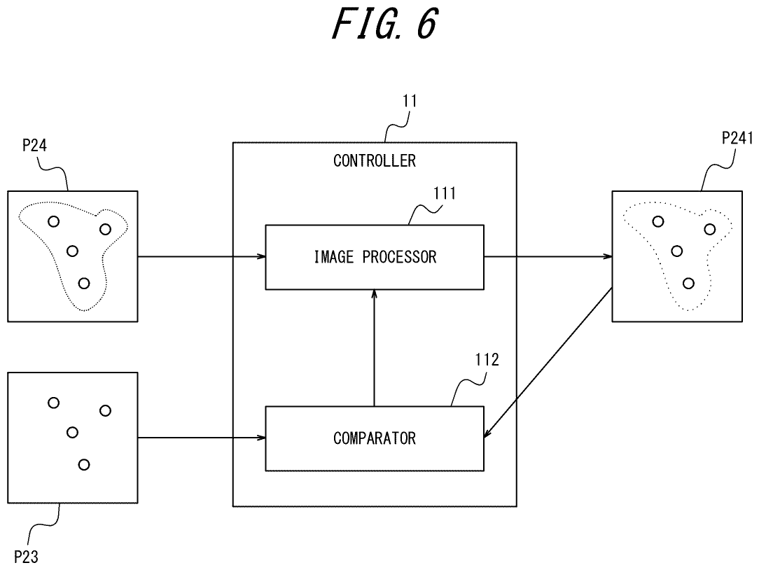

FIG. 6 is a fifth schematic diagram to explain the example of the operations of the information processing apparatus 10 in FIG. 1. A second example of the learning model construction processing performed by the controller 11 of the information processing apparatus 10 is mainly described with reference to FIG. 6. Learning processing of the controller 11 that generates a second image with reduced fluorescence crosstalk, which is similar to the second fluorescence image P23, from the second fluorescence image P24 is mainly described.

The image processor 111 of the controller 11 refers to the second fluorescence image P24 stored in the memory 12. The image processor 111 may perform, for example, processing based on a convolutional neural network having an encoder that captures image features using multiple convolutional layers and a decoder that generates an image by performing inverse operations on the image features using the same number of inverse convolutional layers. The image processor 111 applies, to the second fluorescence image P24, an action to remove the fluorescence crosstalk of the first fluorescence E1, and outputs a second fluorescence image P241 during learning.

The comparator 112 of the controller 11 refers to the second fluorescence image P23 stored in the memory 12 and the second fluorescence image P241 during learning. The comparator 112 compares the second fluorescence image P23 with the second fluorescence image P241 during learning, and adjusts internal parameters of the image processor 111 to bring the second fluorescence image P241 closer to the second fluorescence image P23.

The controller 11 repeatedly performs the above-described processing by the image processor 111 and the comparator 112. The controller 11 performs the same processing on the pairs of second fluorescence images P23 and second fluorescence images P24 captured in the other fields of view. As described above, the controller 11 optimizes the image processor 111 by repeated learning.

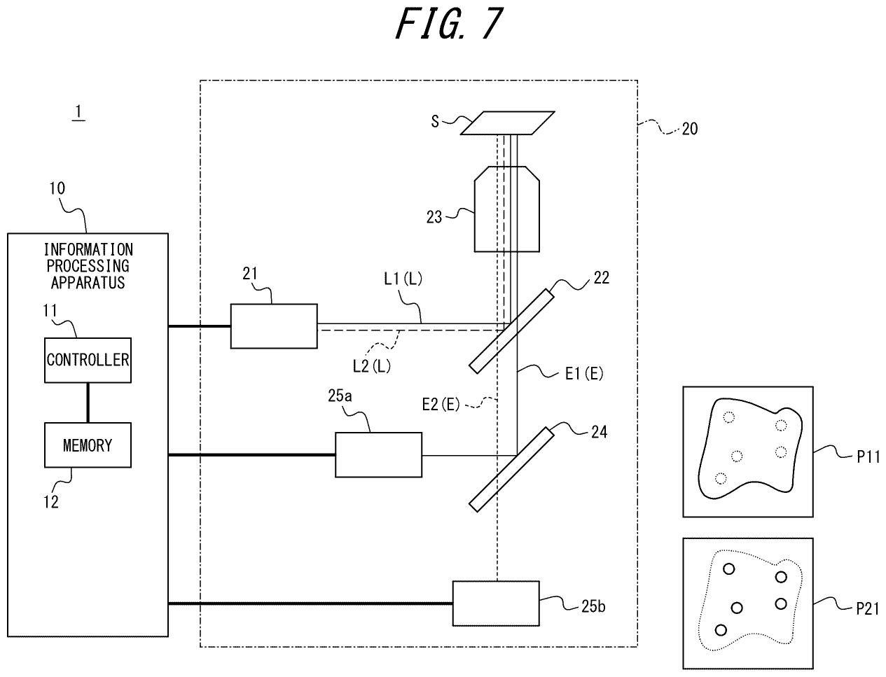

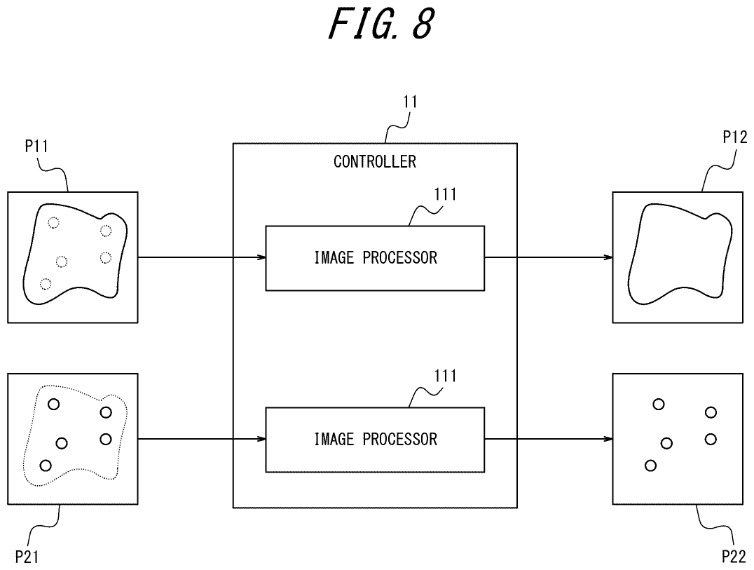

FIG. 7 is a sixth schematic diagram to explain the example of the operations of the information processing apparatus 10 in FIG. 1. FIG. 8 is a seventh schematic diagram to explain the example of the operations of the information processing apparatus 10 in FIG. 1. Generation processing of second images from first images of the sample S acquired by the fluorescence microscope 1, which is performed by the controller 11 of the information processing apparatus 10 based on the constructed learning model, is mainly described with reference to FIGS. 7 and 8. The controller 11 acquires the first images, as fluorescence images of multiple wavelengths when the excitation light L of multiple wavelengths is simultaneously applied to the sample S in the optical system 20 of the fluorescence microscope 1. As an example, operations of simultaneous acquisition of fluorescence at two wavelengths and reduction of fluorescence crosstalk by the information processing apparatus 10 are mainly described.

As illustrated in FIG. 7, the controller 11 controls the applicator 21 to apply the first excitation light L1 and the second excitation light L2. The first excitation light L1 and the second excitation light L2 are reflected by the first dichroic mirror 22, pass through the objective lens 23, and are guided to the sample S. One fluorochrome of the multiple fluorochromes that stain the sample S is excited by the first excitation light L1, and emits the first fluorescence E1. The other fluorochrome of the multiple fluorochromes that stain the sample S is excited by the second excitation light L2, and emits the second fluorescence E2.

The first fluorescence E1 and the second fluorescence E2 pass through the objective lens 23, and transmit through the first dichroic mirror 22. The first fluorescence E1 is reflected by the second dichroic mirror 24, and is incident on the first imaging camera of the first light receiver 25a. At this time, part of the second fluorescence E2 is also reflected by the second dichroic mirror 24, and is incident on the first imaging camera of the first light receiver 25a. The second fluorescence E2 passes through the second dichroic mirror 24, and is incident on the second imaging camera of the second light receiver 25b. At this time, part of the first fluorescence E1 also passes through the second dichroic mirror 24, and is incident on the second imaging camera of the second light receiver 25b.

The controller 11 stores, as a first image, a first fluorescence image P11 acquired from the first light receiver 25a, in the memory 12. The first fluorescence image P11 is an image that includes fluorescence crosstalk of the second fluorescence E2 in the first fluorescence E1. The controller 11 stores, as a first image, a second fluorescence image P21 acquired from the second light receiver 25b, in the memory 12. The second fluorescence image P21 is an image that includes fluorescence crosstalk of the first fluorescence E1 in the second fluorescence E2.

As illustrated in FIG. 8, the image processor 111, in which the learning model has already been constructed, refers to the first fluorescence image P11 stored in the memory 12, and outputs, as a second image, a first fluorescence image P12 with reduced fluorescence crosstalk of the second fluorescence E2. The image processor 111, in which the learning model has already been constructed, refers to the second fluorescence image P21 stored in the memory 12, and outputs, as a second image, a second fluorescence image P22 with reduced fluorescence crosstalk of the first fluorescence E1.

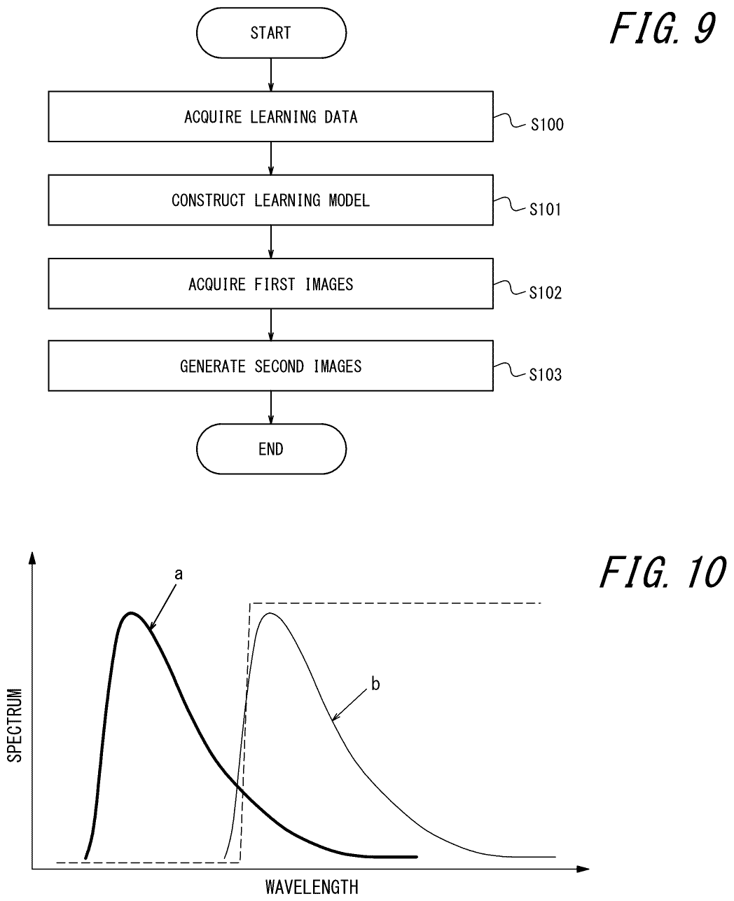

FIG. 9 is a flowchart to explain an example of an information processing method executed by the information processing apparatus 10 in FIG. 1. An example of the information processing method executed by the information processing apparatus 10 in FIG. 1 is mainly described with reference to FIG. 9.

In Step S100, the controller 11 of the information processing apparatus 10 acquires learning data that associates third images, which include no fluorescence crosstalk, with fourth images, which include fluorescence crosstalk.

In Step S101, the controller 11 of the information processing apparatus 10 constructs, based on the learning data acquired in Step S100, a learning model by learning the third images corresponding to the fourth images. The controller 11 thereby acquires the learning model.

In Step S102, the controller 11 of the information processing apparatus 10 acquires first images by controlling the optical system 20 of the fluorescence microscope 1.

In Step S103, the controller 11 of the information processing apparatus 10 generates second images from the first images acquired in Step S102, based on the learning model acquired in Step S101.

The information processing apparatus 10 according to the embodiment as described above can more easily reduce fluorescence crosstalk in the images acquired by the fluorescence microscope 1. The information processing apparatus 10 acquires, based on the learning data, the learning model constructed by learning the third images corresponding to the fourth images.

The information processing apparatus 10 generates, based on the acquired learning model, the second images from the first images. As described above, the information processing apparatus 10, in contrast to conventional technology, can reduce fluorescence crosstalk using only the images, without acquiring fluorescence spectra. The information processing apparatus 10 can more easily reduce fluorescence crosstalk during simultaneous fluorescence imaging at multiple wavelengths, without depending on variations in the fluorescence spectra of the fluorochromes used for the sample S. The information processing apparatus 10 can easily reduce fluorescence crosstalk with high accuracy.

The information processing apparatus 10 acquires each of the first images and the fourth images, as a fluorescence image of multiple wavelengths when the excitation light L of multiple wavelengths is applied simultaneously to the sample S in the optical system 20 of the fluorescence microscope 1. Therefore, the information processing apparatus 10 can efficiently acquire the fluorescence images of the wavelengths different from each other in a short time, both in an observation stage in which the sample S is actually observed, and in a learning stage in which the learning data is acquired to construct the learning model.

The information processing apparatus 10 acquires each of the third images, as a fluorescence image of a single wavelength when the excitation light L is applied, for each wavelength of multiple wavelengths, to the sample S in the optical system 20. Therefore, the information processing apparatus 10 can accurately acquire the third images, which include no fluorescence crosstalk, as the teacher data in the learning data.

The third and fourth images constitute the pair of images captured in the same field of view as each other in the fluorescence microscope 1. This allows the information processing apparatus 10 to acquire the pair of images in which positional information on the sample S in the images is maintained in the same field of view as each other. This improves learning accuracy when the learning model is constructed based on the third and fourth images. The information processing apparatus 10 can accurately generate the second images with reduced fluorescence crosstalk from the first images of the sample S acquired by the fluorescence microscope 1.

The information processing apparatus 10 acquires the multiple pairs of images that are captured in respective multiple fields of view different for each pair from each other. Therefore, the information processing apparatus 10 can also acquire the learning data that includes the more pairs of third and fourth images. The larger the amount of the learning data, the higher the learning accuracy when the learning model is constructed based on the third and fourth images. The information processing apparatus 10 can accurately generate the second images with reduced fluorescence crosstalk, from the first images of the sample S acquired by the fluorescence microscope 1.

The fluorescence microscope 1 is a confocal microscope, thus allowing acquisition of high-resolution images with little blurring and high contrast.

The information processing apparatus 10 acquires the learning data and constructs the learning model by itself, thus completing, in the single apparatus, processing from the learning stage in which the learning model is constructed to the observation stage in which the sample S is actually observed.

The learning model is a machine learning model that has learned the acquired learning data. This improves the learning accuracy when the learning model is constructed based on the third and fourth images. The information processing apparatus 10 can accurately generate the second images with reduced fluorescence crosstalk, from the first images of the sample S acquired by the fluorescence microscope 1.

It is obvious to those skilled in the art that the present disclosure can be realized in other predetermined forms than the above-described embodiment, without departing from the spirit or the essential features thereof. Therefore, the foregoing description is illustrative and not limited thereto. The scope of the disclosure is defined by the appended claims, not by the foregoing description. Any changes within the scope of equivalence of the foregoing description shall be included therein.

For example, the shape, pattern, size, arrangement, orientation, type, number, and the like of each component described above are not limited to the contents of the description and drawings above. The shape, pattern, size, arrangement, orientation, type, number, and the like of each component may be configured arbitrarily as long as the function can be achieved. Each component of the fluorescence microscope 1 and the information processing apparatus 10 illustrated in the drawings is conceptual in terms of function, and the specific form of each component is not limited to that illustrated in the drawings.

The functions and the like included in each of the components or steps described above can be rearranged so that there are no logical contradictions. It is possible to combine multiple components or steps into one, or split one component or step into multiple.

For example, it is also possible to make a general-purpose electronic device, such as a smartphone or a computer, function as the above-described information processing apparatus 10 according to the embodiment. Specifically, a program that describes processing contents that realize each function of the information processing apparatus 10 according to the embodiment is stored in a memory of the electronic device, and a processor of the electronic device reads and executes the program. Therefore, the present disclosure can also be realized as a program executable by a processor.

Alternatively, the present disclosure may also be implemented as a non-transitory computer readable medium storing a program that can be executed by one or more processors, to cause the information processing apparatus 10 or the like according to the embodiment to execute each function. It should be understood that these are also included within the scope of the present disclosure.

In the above embodiment, the third and fourth images are described as being the pair of images captured in the same field of view as each other in the fluorescence microscope 1, but are not limited to this. The third and fourth images may be a pair of images captured in different fields of view from each other in the fluorescence microscope 1, as long as the learning accuracy when constructing the learning model is maintained.

In the above embodiment, the information processing apparatus 10 is described as acquiring the multiple pairs of images captured in respective multiple fields of view different for each pair from each other in the fluorescence microscope 1, but is not limited to this. The information processing apparatus 10 may acquire multiple pairs of images captured in the same field of view for each pair as each other, as long as the learning accuracy when constructing the learning model is maintained. For example, the information processing apparatus 10 may perform image processing such as rotating the sample S, for a pair of third and fourth images captured in a single field of view, to acquire multiple pairs of images. The information processing apparatus 10 may increase the amount of data of the learning data by a method based on such image processing.

In addition to the processing described in the above embodiment, the controller 11 of the information processing apparatus 10 may acquire the first images and the pairs of the third and fourth images, in which at least one of the intensity or application time of the excitation light L applied to the sample S by the optical system 20 of the fluorescence microscope 1 is different from each other. In other words, at least one of the intensity or application time of the excitation light L may be different from each other between the pairs of the third and fourth images used for learning of the image processor 111 and the first images used for actual observation.

This also enables the information processing apparatus 10 to acquire the pairs of third and fourth images, which are used for learning of the image processor 111, with a high signal-to-noise ratio, by increasing the intensity of the excitation light L and/or elongating the application time of the excitation light L when capturing the images. This improves learning accuracy when the learning model is constructed based on the third and fourth images. On the other hand, the information processing apparatus 10 can also reduce damage to the sample S due to the excitation light L, by reducing the intensity of the excitation light L and/or shortening the application time of the excitation light L when capturing the first images used for actual observation. In addition, the information processing apparatus 10 can also shorten the exposure time of the imaging camera contained in each light receiver by shortening the application time of the excitation light L, thereby shortening imaging time.

In the above embodiment, the fluorescence microscope 1 is described as having the information processing apparatus 10, but is not limited to this. The information processing apparatus 10 may not be provided in the fluorescence microscope 1. For example, the information processing apparatus 10 may be an external apparatus that is communicably connected to the fluorescence microscope 1 via a network such as a mobile communication network or the Internet. The external apparatus may include, for example, one server apparatus or multiple server apparatuses communicable with each other.

In the above embodiment, the fluorescence microscope 1 is described as being a confocal microscope, but is not limited to this. The fluorescence microscope 1 may be any other microscope that can acquire images as fluorescence images.

In the above embodiment, the information processing apparatus 10 is described as constructing the learning model by itself, but is not limited to this. The information processing apparatus 10 may acquire the learning model by receiving a learning model that has already been constructed from any other external apparatus via a network such as a mobile communication network or the Internet.

In the above embodiment, the learning model is described as being a convolutional neural network, but is not limited to this. The learning model may be any other machine learning model. The learning model is described as being a machine learning model that has learned the acquired learning data, but is not limited to this. The learning model may be a model based on any other statistical method other than machine learning.

In the above embodiment, the operations of the information processing apparatus 10 are described based on the example of simultaneous fluorescence imaging at two wavelengths, but are not limited to this. The information processing apparatus 10 can also be applied to simultaneous fluorescence imaging at three or more wavelengths, according to the configuration of the optical system 20 of the fluorescence microscope 1.

In the above embodiment, the image processor 111 does not need to re-learn and re-construct a new learning model, as long as the sample S is cultured and stained under the same conditions, and the same learning model may be maintained and applied to first images with fluorescence crosstalk. Not limited to this, the image processor 111 may further perform learning processing and update the learning model.

In the above embodiment, the optical system 20 of the fluorescence microscope 1 is described as having the multiple light receivers that match the number of the types of fluorescence E and as performing fluorescence imaging by the individual light receivers, but is not limited to this. The optical system 20 may have only a single imaging camera, and the fluorescence imaging may be performed individually in different areas of the single imaging camera.

Examples of some embodiments of the present disclosure are described below. However, it should be noted that the embodiments of the present disclosure are not limited to these examples.

### Appendix 1

An information processing apparatus comprising a controller configured to:
acquire, based on learning data that associates a third image with a fourth image, a learning model constructed by learning the third image corresponding to the fourth image, the third image being acquired by a fluorescence microscope and having no fluorescence crosstalk, the fourth image being acquired by the fluorescence microscope and having fluorescence crosstalk; and
generate, based on the acquired learning model, a second image with reduced fluorescence crosstalk in a first image of a sample, the first image being acquired by the fluorescence microscope.

### Appendix 2

The information processing apparatus according to appendix 1, wherein the controller is configured to acquire each of the first image and the fourth image, as a fluorescence image of multiple wavelengths when excitation light of multiple wavelengths is simultaneously applied to the sample in an optical system of the fluorescence microscope.

### Appendix 3

The information processing apparatus according to appendix 2, wherein the controller is configured to acquire the third image, as a fluorescence image of a single wavelength when the excitation light is applied, for each single wavelength of the multiple wavelengths, to the sample in the optical system.

### Appendix 4

The information processing apparatus according to any one of appendices 1 to 3, wherein the third and fourth images are a pair of images that are captured in a same field of view as each other in the fluorescence microscope.

### Appendix 5

The information processing apparatus according to appendix 4, wherein the controller is configured to acquire, in the fluorescence microscope, multiple pairs of images that are captured in respective multiple fields of view different for each pair from each other.

### Appendix 6

The information processing apparatus according to any one of appendices 1 to 5, wherein the controller is configured to acquire the first image and a pair of the third and fourth images in which at least one of intensity or application time of excitation light applied to the sample in an optical system of the fluorescence microscope is different from each other.

### Appendix 7

The information processing apparatus according to any one of appendices 1 to 6, wherein the fluorescence microscope is a confocal microscope.

### Appendix 8

An information processing method performed by an information processing apparatus, the information processing method comprising:
acquiring, based on learning data that associates a third image with a fourth image, a learning model constructed by learning the third image corresponding to the fourth image, the third image being acquired by a fluorescence microscope and having no fluorescence crosstalk, the fourth image being acquired by the fluorescence microscope and having fluorescence crosstalk; and
generating, based on the acquired learning model, a second image with reduced fluorescence crosstalk in a first image of a sample, the first image being acquired by the fluorescence microscope.

### Appendix 9

A method of generating the learning model used in the information processing method according to appendix 8, the method comprising:
acquiring the learning data; and
constructing, based on the acquired learning data, the learning model by learning the third image corresponding to the fourth image.

### Appendix 10

The method of generating the learning model according to appendix 9, wherein the learning model is a machine learning model that has learned the acquired learning data.

### Appendix 11

A non-transitory computer readable medium storing a program executable by one or more processors, the program configured to cause an information processing apparatus to execute any one of the information processing method according to appendix 8 and the methods of generating the learning model according to appendices 9 and 10.

1. An information processing apparatus comprising a controller configured to:
acquire, based on learning data that associates a third image with a fourth image, a learning model constructed by learning the third image corresponding to the fourth image, the third image being acquired by a fluorescence microscope and having no fluorescence crosstalk, the fourth image being acquired by the fluorescence microscope and having fluorescence crosstalk; and
generate, based on the acquired learning model, a second image with reduced fluorescence crosstalk in a first image of a sample, the first image being acquired by the fluorescence microscope.

2. The information processing apparatus according to claim 1, wherein the controller is configured to acquire each of the first image and the fourth image, as a fluorescence image of multiple wavelengths when excitation light of multiple wavelengths is simultaneously applied to the sample in an optical system of the fluorescence microscope.

3. The information processing apparatus according to claim 2, wherein the controller is configured to acquire the third image, as a fluorescence image of a single wavelength when the excitation light is applied, for each single wavelength of the multiple wavelengths, to the sample in the optical system.

4. The information processing apparatus according to claim 1, wherein the third and fourth images are a pair of images that are captured in a same field of view as each other in the fluorescence microscope.

5. The information processing apparatus according to claim 4, wherein the controller is configured to acquire, in the fluorescence microscope, multiple pairs of images that are captured in respective multiple fields of view different for each pair from each other.

6. The information processing apparatus according to claim 1, wherein the controller is configured to acquire the first image and a pair of the third and fourth images in which at least one of intensity or application time of excitation light applied to the sample in an optical system of the fluorescence microscope is different from each other.

7. The information processing apparatus according to claim 1, wherein the fluorescence microscope is a confocal microscope.

8. An information processing method performed by an information processing apparatus, the information processing method comprising:
acquiring, based on learning data that associates a third image with a fourth image, a learning model constructed by learning the third image corresponding to the fourth image, the third image being acquired by a fluorescence microscope and having no fluorescence crosstalk, the fourth image being acquired by the fluorescence microscope and having fluorescence crosstalk; and
generating, based on the acquired learning model, a second image with reduced fluorescence crosstalk in a first image of a sample, the first image being acquired by the fluorescence microscope.

9. A method of generating the learning model used in the information processing method according to claim 8, the method comprising:
acquiring the learning data; and
constructing, based on the acquired learning data, the learning model by learning the third image corresponding to the fourth image.

10. The method of generating the learning model according to claim 9, wherein the learning model is a machine learning model that has learned the acquired learning data.

11. A non-transitory computer readable medium storing a program executable by one or more processors, the program configured to cause an information processing apparatus to execute the information processing method according to claim 8.

12. A non-transitory computer readable medium storing a program executable by one or more processors, the program configured to cause an information processing apparatus to execute the method of generating the learning model according to claim 9.
